(19) United States
(12) Patent Application Publication
(10) Pub. No.: US 2005/0157642 A1
(43) Pub. Date: Jul. 21, 2005

(54) Method of optimizing packet flow in a ring stackable network architecture

(75) Inventor: Tzong-Feng Chen, Hsinchu (TW)

Correspondence Address: BACON & THOMAS, PLLC, 625 SLATERS LANE, FOURTH FLOOR, ALEXANDRIA, VA, 22314, US

(73) Assignee: Alpha Networks Inc., Hsinchu (TW)

(21) Appl. No.: 10/760,344

(22) Filed: Jan. 21, 2004

(51) Int. Cl. H04J 1/16

(52) U.S. Cl. 370/222

(57) ABSTRACT

The present invention is to provide a method of optimizing packet flow and fully utilizing available bandwidth in a packet transfer path of duplex ring stackable switch, which comprises implementing in a ring network including a plurality of switches; setting a plurality of interruption points each at a location farthest from a unique one of the switches; dividing a packet output path of each switch into two different transfer paths; selecting either transfer path based on an initialization when one of the switches is about to send a packet to the other switch; and sending the packet from one switch to the other switch along the selected transfer path.

### FIELD OF THE INVENTION

The present invention relates to flow optimization in a ring stackable network architecture and more particularly to a method of optimizing packet flow in such a ring stackable network architecture with improved characteristics.

### BACKGROUND OF THE INVENTION

Over the past decade there has been a significant growth in network technology, leading to an increasing development of various network products which, in turn, are widely used in our daily life and almost all trades. Such trend of expansion not only increases speed and efficiency of information communication but also brings a great convenience to our life and work.

A stacking network system is the most widely employed one among a great number of network systems. Such network system has been widely used in almost all trades and has the potential of becoming the dominant type of future network systems. A network switching apparatus mounted in the stacking network system is adapted to establish an active topology by using a spanning tree protocol in which an alternative path is selected to avoid a loop from being formed in the network. Otherwise, a severe error may occur. Moreover, it can improve reliability of LAN (local area network).

In a ring network, a loop is formed by a trunk cable connecting all devices together. In fact, the loop comprises a plurality of cable sections (i.e., a portion from one point to an adjacent point). Data is adapted to flow in a predetermined (e.g., clockwise or counterclockwise) direction along the ring network.

Data is also broadcasted along the loop for transferring to each coupled computer due to the nature of loop. In other words, a loop is formed by the cable in the ring network in which all nodes are coupled to the loop. Also, the nodes in the loop will sequentially read data. Hence, each node is able to retrieve information from the cable and thus determine whether arrived data belongs to itself or not based on the specified address contained in data. The node has to transfer data unchanged to an immediate next node after receiving data.

Moreover, for the prevention of infinite loop, a packet based closed loop is not allowed to exist in Ethernet. Therefore, in most cases certain section of the closed loop is interrupted for stopping data transfer and receiving. Such scheme aims at providing a backup transfer path.

However, bandwidth of the loop cannot be totally utilized as illustrated in a prior ring network 1 architecture in FIG. 1. As shown, there are a plurality of switches including switch A, switch B, switch C, switch D, switch E, switch F, and switch G in a ring network 1. A duplex ring stackable switch is formed by all of the switches. Line between the switches F and G is interrupted (i.e., interruption point) for preventing an infinite loop from occurring. Unfortunately, a first packet issued from a computer a has to traverse the switches A, B, C, D, E, and F prior to reaching a computer f. At the same time, a second packet issued from a computer a has to traverse the switches A, B and C prior to reaching a computer c (i.e., in the same direction as the first packet). This means that bandwidth of the same path is occupied by a packet sent from the computer a to the computer c or the computer f.

In other words, the above undesired bandwidth occupation can be avoided if the packet issued from the computer a is sent to the computer f via a direct path from the switch G to the switch F (i.e., transfer distance shortened). Unfortunately, the scheme of interruption point eliminates the possibility of effectively and efficiently utilizing a bandwidth between the switches F and G.

Thus, it is desirable to provide a method of optimizing packet flow along a path in a duplex ring stackable switch in order to fully utilize all available bandwidth and alternative paths and increase packet transfer efficiency.

### SUMMARY OF THE INVENTION

A primary object of the present invention is to provide a method of optimizing packet flow in a ring stackable network architecture. By utilizing the present invention, the above drawbacks of the prior art such as inefficiency and large bandwidth occupation in a packet transfer path of duplex ring stackable switch can be overcome.

One object of the present invention is to provide a method of optimizing packet flow and fully utilizing available bandwidth in a packet transfer path of duplex ring stackable switch. The method comprises implementing in a ring network including a plurality of switches; setting a plurality of interruption points each at a location farthest from a unique one of the switches; dividing a packet output path of each switch into two different transfer paths; selecting either transfer path based on an initialization when one of the switches is about to send a packet to the other switch; and sending the packet from one switch to the other switch along the selected transfer path, thereby achieving purposes of optimizing flow and fully utilizing available bandwidth. By utilizing the present invention, the purposes of optimizing flow and fully utilizing available bandwidth can be achieved.

The above and other objects, features and advantages of the present invention will become apparent from the following detailed description taken with the accompanying drawings.

### BRIEF DESCRIPTION OF THE DRAWINGS

FIG. 1 presents schematically the connection of a prior ring network architecture; and

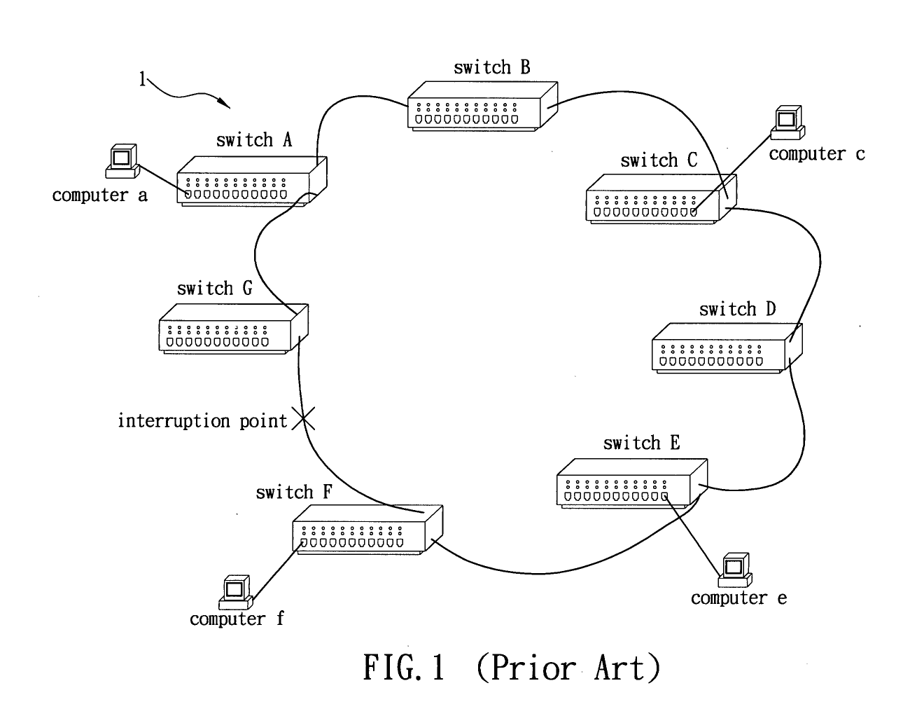

FIG. 2 presents schematically the connection of a ring stackable network architecture according to a preferred embodiment of the invention.

### DETAILED DESCRIPTION OF THE PREFERRED EMBODIMENTS

The invention is directed to a method of optimizing packet flow in a ring stackable network architecture. The method comprises implementing in a ring network including a plurality of switches; setting a plurality of interruption points each at a location farthest from a unique one of the switches; dividing a packet output path of each switch into two different transfer paths; selecting either transfer path based on an initialization when one of the switches is about to send a packet to the other switch; and sending the packet from one switch to the other switch along the selected transfer path. As an end, the purposes of optimizing flow and fully utilizing all available bandwidth can be achieved.

A preferred embodiment of the invention will be described in detail below so that the objects and advantages of the invention will become more apparent. While it is appreciated by those skilled in the art that it is not intended to limit the invention. In other words, the invention can be practiced in forms other than that described in the preferred embodiment. All means capable of sending a packet along either transfer path are within the scope of the invention.

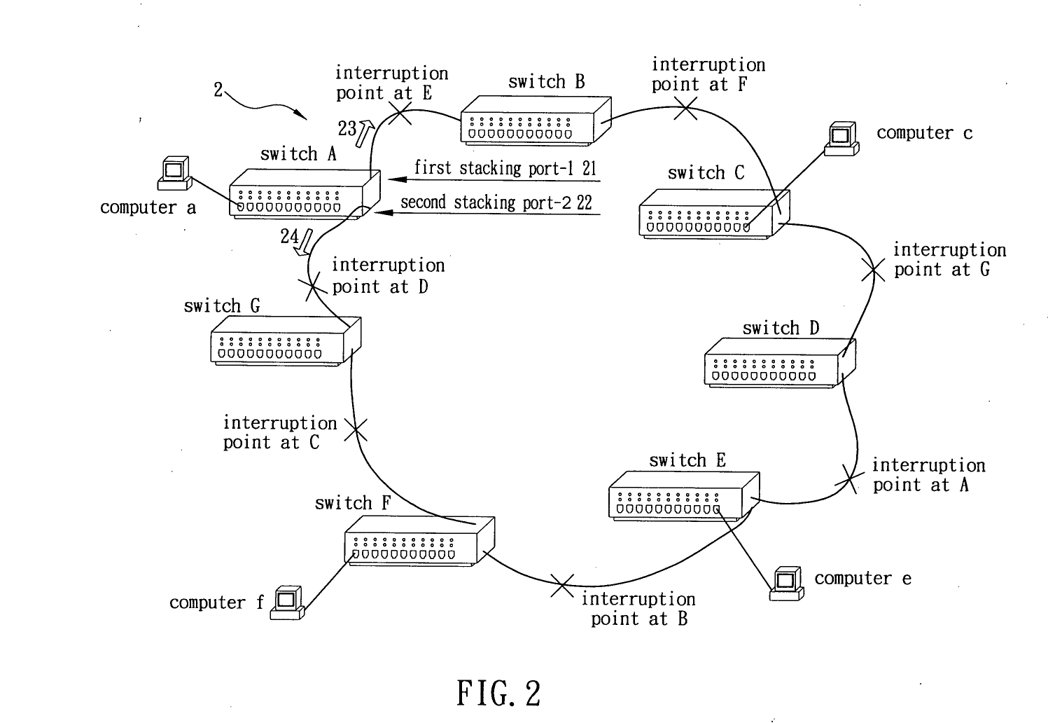

Referring to FIG. 2, there is shown a preferred embodiment of the invention. As shown, there are a plurality of switches in a ring network 2. Each switch has a first stacking port-1 21 and a second stacking port-2 22 in such closed loop scheme. A transfer path (e.g., either first transfer path 23 or second transfer path 24) of sending packet from each switch is set in an initialization. The first transfer path 23 is coupled to the first stacking port-1 21 and the second transfer path 24 is coupled to the second stacking port-2 22. When a computer coupled to a switch is about to send a packet to another computer coupled to another switch, the packet will be sent from a stacking port along a transfer path both associated with another switch.

For example, there are seven switches including switch A, switch B, switch C, switch D, switch E, switch F and switch G along a clockwise direction in a closed loop of the ring network 2 as shown in FIG. 2. Each switch has a first stacking port-1 21 and a second stacking port-2 22. A transfer path of sending packet from each switch is set in the initialization. Moreover, a computer a is coupled to the switch A, a computer c is coupled to the switch C, a computer e is coupled to the switch E, and a computer f is coupled to the switch F.

It is now assumed that a first packet is sent from the first stacking port-1 21 of the switch A to the switch B, the switch C, or the switch D along the first transfer path 23. Also, a second packet is sent from the second stacking port-2 22 of the switch A to the switch E, the switch F, or the switch G along the second transfer path 24.

By configuring as above, in a case of sending a first packet from the computer a coupled to the switch A to the computer e coupled to the switch E, the first packet is sent from the second stacking port-2 22 along the second transfer path 24. That is, the first packet is sent to the computer e by traversing the switches G, F, and E.

To the contrary, in another case of sending a second packet from the computer a coupled to the switch A to the computer c coupled to the switch C, the second packet is sent from the first stacking port-1 21 along the first transfer path 23. That is, the second packet is sent to the computer c by traversing the switches B and C. As an end, the purposes of avoiding two packets from using the same transfer path, optimizing the flow, and fully utilizing bandwidth are achieved.

A path determination software or chip is installed in each switch in the embodiment. Hence, when a computer coupled to a switch is about to send a packet to another computer coupled to another switch, the path determination software or chip is adapted to compare and select a correct stacking port and a correct transfer path based on the destination of the packet. As an end, a successful packet transfer can be carried out.

Likewise, each switch (e.g., the switch B, the switch C, the switch D, the switch E, the switch F, or the switch G) in the preferred embodiment is able to achieve the same purposes. Thus a detailed description thereof is omitted herein for the sake of brevity.

While the invention has been described by means of specific embodiments, numerous modifications and variations could be made thereto by those skilled in the art without departing from the scope and spirit of the invention set forth in the claims.

1. A method of optimizing packet flow in a ring stackable network architecture, comprising:
implementing in a ring network including a plurality of switches;
setting a plurality of interruption points each at a location farthest from a unique one of the switches;
dividing a packet output path of each switch into two different transfer paths;
selecting either transfer path based on an initialization when one of the switches is about to send a packet to the other switch; and
sending the packet from one switch to the other switch along the selected transfer path, thereby achieving purposes of optimizing flow and fully utilizing available bandwidth.

2. The method of claim 1, wherein each switch comprises a first stacking port and a second stacking port.

3. The method of claim 2, wherein with respect to the packet output path of each switch one transfer path is set as a first transfer path and the other transfer path is set as a second transfer path prior to the initialization, removing one switch, or adding a switch.

4. The method of claim 3, wherein the first transfer path is coupled to the first stacking port and the second transfer path is coupled to the second stacking port.

5. The method of claim 4, wherein a correct one of the first and second stacking ports is selected for a packet based on the initialization when a first computer coupled to one switch is about to send the packet to a second computer coupled to the other switch.

6. The method of claim 4, wherein each switch comprises a path determination software or chip so that when a first computer coupled to one switch is about to send a packet to a second computer coupled to the other switch, the path determination software or chip is adapted to compare and select a correct one of the first and second stacking ports and a correct one of the transfer paths based on a destination of the packet prior to transfer.
